(19) United States
(12) Patent Application Publication
(10) Pub. No.: US 2026/0154171 A1
(43) Pub. Date: Jun. 4, 2026

(54) Drift-Based Margin Optimizer

(71) Applicants: Advanced Micro Devices, Inc, Santa Clara, CA (US); Xilinx, Inc., San Jose, CA (US)

(72) Inventors: Hing Yan To, Cupertino, CA (US); Shiv Natarajan, Austin, TX (US); Anwar Parvez Kashem, Sudbury, CA (US)

(73) Assignees: Advanced Micro Devices, Inc, Santa Clara, CA (US); Xilinx, Inc., San Jose, CA (US)

(21) Appl. No.: 19/404,786

(22) Filed: Dec. 1, 2025

Related U.S. Application Data
(60) Provisional application No. 63/727,611, filed on Dec. 3, 2024.

(51) Int. Cl. G06F 11/30; G06F 1/26

(52) U.S. Cl. CPC G06F 11/3024; G06F 1/26

(57) ABSTRACT

Optimizing timing margins across conditions is described. In one or more implementations, a computing system may include an interface circuitry configured to adjust a timing alignment of first and second signals between a central processing unit (CPU) of the system and a device coupled with the CPU and to measure and store one or more margins between the timing alignment and misalignments of the first and second signals. The interface circuitry may be configured to measure and store the timing margins at first and second conditions. The first and second conditions may be different voltages, temperatures, etc. The system may be configured to force the first and/or second condition. The system may be configured to calculate a coefficient from differences in between the margins and between the first and second conditions.

### RELATED APPLICATIONS

This application claims priority to U.S. Application No. 63/727,611, titled Drift Based Margin Optimizer, filed Dec. 3, 2024, which is hereby incorporated by reference in its entirety.

### BACKGROUND

Processing and other complex systems sometimes include multiple separately manufactured components that are assembled together with little foreknowledge of the characteristics and compatibilities of the other components. For example, a processing system may be assembled from components (e.g., semiconductor dies) that are manufactured on separate processes but that, despite having very different characteristics and behaviors, will continually interact as interconnected parts of the aggregated processing system.

### BRIEF DESCRIPTION OF THE DRAWINGS

FIG. 1 is a block diagram of a processing system configured to execute one or more applications, in accordance with one or more implementations.

FIGS. 2A and 2B are block diagrams of a processing system having a computing device configured to align the timing of signals between the computing device and other devices in the system.

FIG. 3 includes a block diagram and a timing diagram illustrating a group of electrical connections configured to carry a group of signals between the computing device and the separate device, as well as example timing alignments of signals between the devices.

FIG. 4 includes a timing diagram and a plot illustrating potential effects of drifting conditions on the timing alignments and margins of signals between the computing device and the separate device.

FIG. 5 depicts a procedure in an example implementation of adjusting an alignment of first and second signals between first and second devices and of measuring margins between alignment and misalignments of the signals at first and second conditions.

### DETAILED DESCRIPTION

Multiple semiconductor dies and/or integrated circuit (IC) packages can be assembled into a processing system despite having very disparate behaviors, e.g., timing characteristics. As an example, a relatively fast central processing unit (CPU) may be combined on a board with a relatively slow memory module or vice versa, e.g., depending on the respective processes and process corners of the semiconductor dies. In at least some such cases, the faster component (e.g., the CPU die or package) and the system as a whole are slowed down to accommodate the slower component (e.g., the memory module). Furthermore, the processing system and/or the CPU may be designed conservatively to accommodate other, slower components whether or not the actual system as assembled includes such components.

These differences may be exacerbated by other differences between system components, such as dynamic random-access memory (DRAM) modules, etc., which may have varying rates of voltage and phase drift as a function of temperature and supply voltage deviations from nominal conditions. Timing differences at startup or initialization can worsen as the system warms up or a power supply droops. Timing compensation or other accommodations made by the system may degrade and benefit from recalibration if the components behave differently over voltage, temperature, etc. For example, an initialization (e.g., a slow, iterative training) by a CPU of a device in the system (but external to the CPU), such as a timing alignment with a memory module, input/output (I/O) device, etc., may become invalid and communication between the system components inoperable if a voltage or temperature drifts too much from the initial conditions during training. Regular operations of the system may be interrupted while a slow, iterative retraining is performed.

Training algorithms are introduced and described that characterize the behavior of data, command, and/or timing signals (e.g., at multiple conditions) and then calculate a drift coefficient that models relative timing alignments of the signals temporally. The drift coefficient enables the checking of timing margins over conditions (such as voltage, temperature, etc.) and, if necessary, the realignment of the signals without having to perform a slow, iterative retraining. The drift characterization provides process understanding and allows for the optimization of power curves and other tuned parameters, such as decision feedback equalization (DFE). Such optimizations can improve system margins across process and voltage variations.

With the described technique, the signals between system components (such as a CPU and a DRAM module) can be trained (e.g., temporally aligned) by maximizing the timing margins between a given pair of signals, and the maximized margins can be measured and stored (e.g., for later comparison with margins at a different condition). For example, the signals may be aligned and their timing margins maximized by time or phase shifting one of the signals relative to the other to determine an alignment window, including margins to signal misalignments at both edges of the window. Once the first margins are determined at a first (e.g., nominal) condition and stored, a second condition can be established and the margins measured at the second condition and stored. As an example, the system can assert a higher or lower supply or control voltage to characterize a timing shift caused by the voltage shift. In another example, the system can adjust a temperature to characterize a timing shift caused by the temperature shift.

The timing shift is calculated by comparing (e.g., by a comparator) the stored timing margins measured at the two conditions. In one or more implementations, the technique utilizes or is implemented by interface circuitry (e.g., I/O circuitry and/or logic) that couples the CPU with the other device. As an example, the system divides the timing shift by the condition shift to yield a coefficient or factor (e.g., a “drift coefficient”) that combines the observed changes into a predictive multiplier for calculating timing margins even at conditions other than those used in the initial training or aligning of the signals.

With this predictive coefficient, the system is able to verify satisfactory margins over a wide range of conditions, e.g., by extrapolating the coefficient to conditions beyond those used for training. If the coefficient predicts that margins will be insufficient at an expected condition, the coefficient is used by the system to realign the signals, e.g., by resetting the I/Os and rebalancing the margins, without having to train again. The described techniques and capabilities improve system performance by maximizing timing margins across conditions and by minimizing latency or down time, e.g., by preventing system interruptions for retraining.

In some aspects, the techniques described herein relate to a computing system, including an interface circuitry configured to adjust a timing alignment between a first signal and a second signal transmitted between a central processing unit (CPU) of the computing system and a device coupled with the CPU, measure and store one or more first margins between the timing alignment and a misalignment of the first signal and the second signal at a first condition and one or more second margins between the timing alignment and the misalignment of the first signal and the second signal at a second condition, and output an indication of whether to readjust the timing alignment between the first signal and the second signal at a third condition based on the one or more first margins and the one or more second margins.

In some aspects, the techniques described herein relate to a computing system, wherein the computing system is configured to calculate a coefficient from a first difference between the one or more first margins at the first condition and the one or more second margins at the second condition, and a second difference between the first condition and the second condition.

In some aspects, the techniques described herein relate to a computing system, wherein the computing system is configured to calculate one or more third margins at the third condition based on the coefficient, and output the indication of whether to readjust the timing alignment at the third condition based on a magnitude of the one or more third margins at the third condition.

In some aspects, the techniques described herein relate to a computing system, wherein the interface circuitry is configured to readjust the timing alignment at the third condition based on the coefficient and the one or more third margins.

In some aspects, the techniques described herein relate to a computing system, wherein the interface circuitry is configured to adjust the timing alignment by adjusting a voltage of the computing system.

In some aspects, the techniques described herein relate to a computing system, wherein the interface circuitry is configured to force at least the second condition.

In some aspects, the techniques described herein relate to a computing system, wherein the first condition includes a first voltage, and the second condition includes a second voltage.

In some aspects, the techniques described herein relate to a computing system, wherein the first condition includes a first temperature, and the second condition includes a second temperature.

In some aspects, the techniques described herein relate to a computing system, further including the device, wherein the device includes a memory module, and the CPU is coupled to the memory module via a first trace and a second trace, the first trace configured to carry the first signal, the second trace configured to carry the second signal.

In some aspects, the techniques described herein relate to a computing system, wherein the first signal is a read strobe, the second signal is a data signal, the device is coupled with the CPU by a printed circuit board, the printed circuit board including the first trace and the second trace, and the interface circuitry is configured to adjust the timing alignment between the read strobe and the data signal by adjusting a voltage.

In some aspects, the techniques described herein relate to a computer-implemented method, including adjusting an alignment of a first signal and a second signal between a first device and a second device, measuring at a first condition one or more first margins between the alignment and a misalignment of the first signal and the second signal, measuring at a second condition one or more second margins between the alignment and the misalignment of the first signal and the second signal, and outputting an indication of whether to readjust the alignment of the first signal and the second signal at a third condition based on the one or more first margins and the one or more second margins.

In some aspects, the techniques described herein relate to a computer-implemented method, further including forcing the first condition, and forcing the second condition.

In some aspects, the techniques described herein relate to a computer-implemented method, further including calculating a drift coefficient from a first difference between the one or more first margins at the first condition and the one or more second margins at the second condition, and a second difference between the first condition and the second condition.

In some aspects, the techniques described herein relate to a computer-implemented method, further including calculating one or more third margins at the third condition based on the drift coefficient, and adjusting the alignment of the first signal and the second signal at the third condition based on the one or more third margins.

In some aspects, the techniques described herein relate to a computer-implemented method, further including adjusting the alignment of the first signal and the second signal by adjusting a voltage of the first device or the second device.

In some aspects, the techniques described herein relate to a computing system, including a printed circuit board including at least a first trace and a second trace, the first trace configured to carry a first signal, the second trace configured to carry a second signal, a first device on the printed circuit board, the first device configured to communicate with a second device by the first trace and the second trace, and the second device on the printed circuit board, configured to adjust a phase relationship between the first signal and the second signal, measure and store one or more first margins between a first transition of the first signal and one or more second transitions of the second signal at a first condition and one or more second margins between the first transition of the first signal and the one or more second transitions of the second signal at a second condition, and output an indication of whether to readjust the phase relationship between the first signal and the second signal at a third condition based on the one or more first margins and the one or more second margins.

In some aspects, the techniques described herein relate to a computing system, wherein the computing system is configured to calculate a coefficient from a first difference between the one or more first margins at the first condition and the one or more second margins at the second condition, and a second difference between the first condition and the second condition.

In some aspects, the techniques described herein relate to a computing system, wherein the computing system is configured to calculate one or more third margins at the third condition based on the coefficient, and output the indication of whether to readjust the phase relationship at the third condition based on a magnitude of the one or more third margins at the third condition.

In some aspects, the techniques described herein relate to a computing system, wherein the computing system is configured to readjust the phase relationship at the third condition based on the coefficient and the one or more third margins.

In some aspects, the techniques described herein relate to a computing system, wherein the first condition includes a first voltage, and the second condition includes a second voltage.

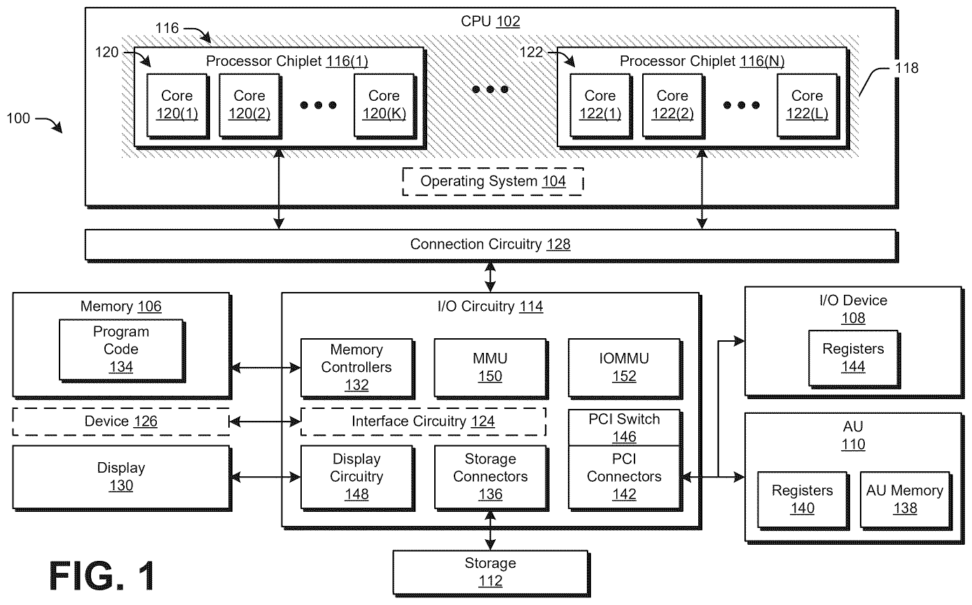

FIG. 1 is a block diagram of a processing system configured to execute one or more

applications, in accordance with one or more implementations.

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116(N) of the CPU 102 such that each processor core (e.g., processor cores 120) of a first processor chiplet (e.g., processor chiplet 116(1)) is communicatively coupled to each processor core (e.g., processor cores 122) of one or more other processor chiplets 116. Though the example presented in FIG. 1 shows a first processor chiplet (processor chiplet 116(1)) having three processor cores (120(1), 120(2), 120(K)) representing a K number of processor cores 122 and a second processor chiplet (116(N)) having three processor cores (e.g., 122(1), 122(2), 122(L)) representing an L number of processor cores 122 (L being an integer number greater than or equal to one), in other implementations, each processor chiplet 116 has any number of suitable processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

In this example, an interface circuitry 124 is depicted in the I/O circuitry 114 of the processing system 100. In variations, however, the interface circuitry 124 is included in and/or is implemented by one or more different components of the processing system 100, such as the CPU 102, the memory 106, the I/O device 108, the AU 110, the storage 112, and so forth. The interface circuitry 124 is coupled with a device 126 (e.g., a peripheral device 126), and one or more components of the processing system 100 (such as the CPU 102) are coupled with the device 126 via the interface circuitry 124.

In variations, the device 126 is not a separate device and is included in and/or is implemented by one or more components of the processing system 100 shown in FIG. 1, such as the CPU 102, the memory 106, the I/O device 108, the AU 110, the storage 112, and so forth. In variations with the device 126 included in and/or implemented by one or more shown components of the processing system 100 (such as the memory 106, the I/O device 108, the AU 110, the storage 112, the display 130, etc.), the interface circuitry 124 includes, is included in, and/or is implemented by one or more corresponding components, e.g., of the I/O circuitry 114 (such as memory controllers 132, peripheral component interconnect (PCI) connectors 142, storage connectors 136, a display circuitry 148, etc.). In at least one implementation, the interface circuitry 124 is (or portions of the interface circuitry 124 are) included in at least two of the depicted components of the processing system 100. By way of example, the interface circuitry 124 may be included in or otherwise implemented by at least the I/O circuitry 114 and a connection circuitry 128.

Additionally, within the processing system 100, the CPU 102 is communicatively coupled to the I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, PCI devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 132 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 134 (e.g., an executable file) associated with the application from, for example, a storage 112 into system memory 106. This storage 112, for example, includes a non-volatile storage such as a flash memory, solid-state memory, hard disk, optical disc, or the like configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 150 and input-output memory management unit (IOMMU) 152. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

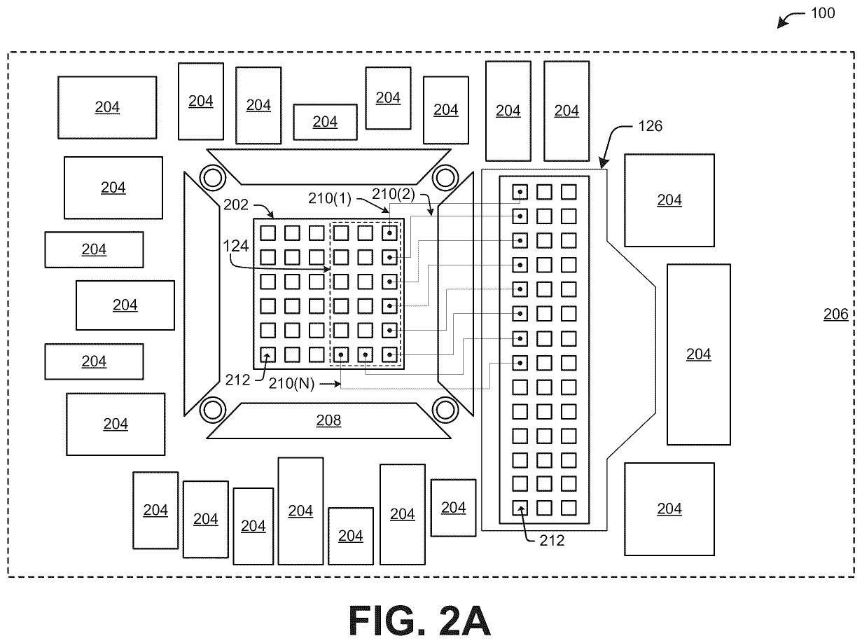

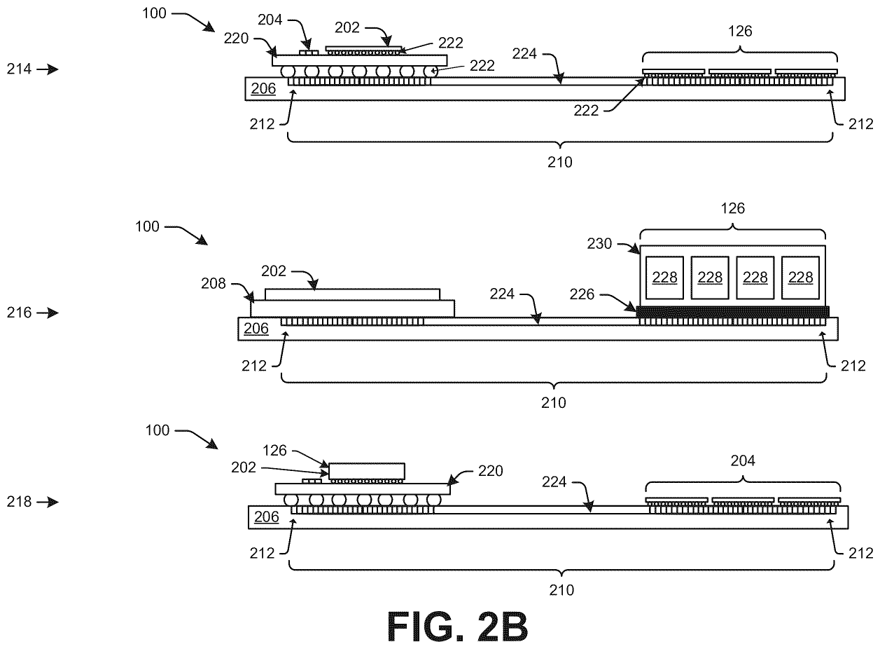

FIGS. 2A and 2B are block diagrams of a processing system having a computing device configured to align the timing of signals between the computing device and other devices in the system.

FIG. 2A depicts a device 202 (e.g., a computing device 202) in the processing system 100 and coupled with various other devices 126, 204 on a printed circuit board (PCB) 206. The computing device 202 (e.g., the interface circuitry 124) is configured to adjust one or more timing alignments between one or more pairs of signals passing between the computing device 202 (e.g., the CPU 102) and the coupled device 126. The computing device 202 (including a CPU in the device 202, such as the CPU 102) is coupled with the second device 126 by the interface circuitry 124. In one or more implementations, the interface circuitry 124 is configured to measure and store one or more margins between the one or more timing alignments and corresponding misalignments of the one or more pairs of signals.

In the example of FIG. 2A, the devices 126, 202 are coupled by the PCB 206. In this context, the term “coupled” refers to a direct or indirect connection, such as a direct (electrical, mechanical, etc.) connection between the coupled things or an indirect connection, e.g., through one or multiple intermediate things. The computing device 202 is coupled to the PCB 206 by a socket 208, and the second device 126 is coupled to the PCB 206 by a connector (not shown), e.g., between the PCB 206 and the device 126. The devices 126, 202 are coupled (e.g., electrically coupled) by multiple connections 210 (e.g., electrical connections 210(1) to 210(N)) through the PCB 206. The electrical connections 210 are configured to carry (e.g., support the conveyance or transmission of) signals between the devices 126, 202. In one or more implementations, the electrical connections 210 between the devices 126, 202 include interfaces 212 (e.g., interconnect interfaces 212, such as land pads or other contacts) of the devices 126, 202 and the socket 208 and other connectors.

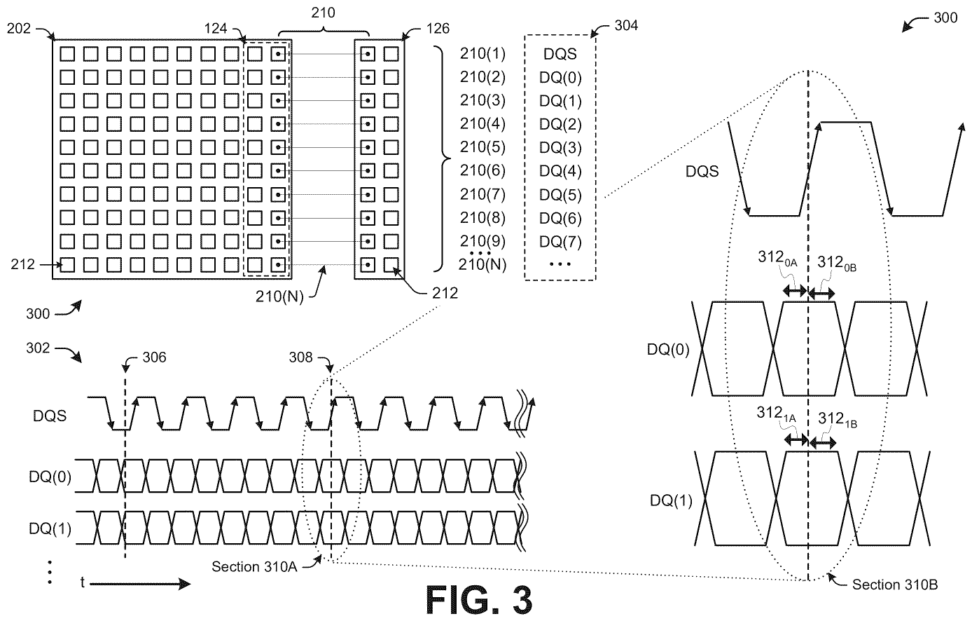

The computing device 202 includes at least one interface circuitry 124, e.g., as shown, coupled with the second device 126, and the interface circuitry 124 interfaces with the device 126, e.g., by connections 210. The interface circuitry 124 is a group of circuitries (e.g., including logic), and one or more of the circuitries are configured to adjust a timing alignment between at least a first signal and a second signal, such as first and second signals transmitted between a CPU (e.g., the CPU 102 of the system 100) and the device 126 coupled with the CPU. The adjusting the timing alignment adjusts a phase relationship between the first and second signals, e.g., between a first transition of the first signal and one or more second transitions of the second signal. In one example, the first and second signals are on electrical connections 210(1) and 210(2) between the second device 126 and a CPU in the computing device 202 (e.g., the CPU 102). In the same and/or another example, the interface circuitry 124 is configured to adjust timing alignments between a signal on connection 210(1) and multiple signals on multiple ones of connections 210(2)-210(N) between the coupled device 126 and a CPU in the device 202. Example alignments are illustrated and further described at least at FIG. 3.

The first and second (etc.) signals are transmitted between the CPU (e.g., the CPU 102) and the coupled device 126 in either (e.g., both) directions. The one or more signals can be command, data, or other signals. In at least one variation, a timing signal (such as a strobe) is transmitted (e.g., asserted on) a line or trace (such as in an electrical connection 210) in a first direction (e.g., by the interface circuitry 124) during a first operation (e.g., a write operation from the CPU) and in a second direction (e.g., by the coupled device 126) during a second operation (e.g., a read operation to the CPU). In a variation, one or more data signals are transmitted on a line or bus (such as one or more electrical connections 210) in a first direction (e.g., by the interface circuitry 124) during a first operation (e.g., a write operation from the CPU) and in a second direction (e.g., by the coupled device 126) during a second operation (e.g., a read operation to the CPU).

The second device 126 of FIG. 2A is in an integrated circuit (IC) package coupled with (but separate from) the computing device 202, on the same motherboard or other PCB 206 as the computing device 202. The separate device 126 is coupled and electrically connected to the computing device 202 by the motherboard or other PCB 206, e.g., by electrical connections 210 that include portions (such as electrical traces) of the PCB 206. In at least one implementation, the coupled device 126 is part of (e.g., not separate from) the processing system 100, though separate from the interface circuitry 124 and the device 202. In one example, the computing device 202 and the separate device 126 are separate dies in the same IC package.

The second device 126 is any suitable type of coupled device 126. In some implementations, the separate device 126 is a memory device 126, whether a DRAM or not, such as a high-bandwidth memory (HBM), a compression attached memory module (CAMM), CAMM2, low-power CAMM2 (LPCAMM2), etc. In other implementations, the separate device 126 is some other type of device 126, whether described at FIG. 1 (such as an I/O device 108, an AU 110, a display 130, etc.) or not. Whether the coupled device 126 is a memory, display, I/O, or other type of device 126, the signals (and their alignment) between the devices 126, 202 is key to the operation of one or both of the devices 126, 202.

Adjusting (e.g., optimizing) the alignment between the signals improves performance of the processing system 100. In some cases, at least a first signal is a timing signal (such as a clock or strobe signal), and one or more other signals are data signals. Such a timing signal serves to indicate when an associated data signal is to be transferred or sampled (e.g., as a sample trigger), and properly aligned signals ensure data is successfully transferred between the devices 126, 202. Other signals can be command signals, e.g., whose assertion (or not) can be synchronized by a clock or other timing signal.

In one or more implementations, the interface circuitry 124 is configured to adjust the timing alignment of the signals by any suitable means. In one or more implementations, the interface circuitry 124 is configured to insert one or more delays (e.g., one or multiple delay circuits of 20 picoseconds (ps)) into one or both signal paths (e.g., within the interface circuitry 124) for a pair of signals. In one implementation, the interface circuitry 124 is configured to insert one or more phase shifts (e.g., phase-shift circuits of 90°, 180°, or 270°) into one or both signal paths for the pair of signals. In another implementation, the interface circuitry 124 is configured to adjust (e.g., increase or decrease) a voltage to the second device 126 or to the one or multiple delay circuits (e.g., within the interface circuitry 124) to adjust a relative delay (e.g., a phase relationship or timing alignment) between the first and second signals. These and other alignment techniques can be used, alone or in combination, to achieve a satisfactory (e.g., optimal) alignment between the signals.

In various scenarios, alignments between signals differs for different pairs of signals. In one or more scenarios, properly aligned first and second signals are not in-phase, but have an intentionally offset phase relationship, such as an offset of 90°, etc. In one such example, a transition (e.g., a low-to-high transition) in a first signal is aligned (e.g., temporally) with a center of a high (or low) value in a second signal offset from the first signal by 90°. In another example, a transition (e.g., a low-to-high transition) in a first signal is aligned (e.g., temporally) with a center of a high (or low) value in a second signal offset from the first signal by 90°.

In at least one implementation, the interface circuitry 124 is configured to measure and store one or more margins between the timing alignment and a misalignment of the signals (e.g., first and second signals between the devices 126, 202). In at least one variation, the interface circuitry 124 is configured to measure and store margins between timing alignments and misalignments of multiple (pairs of) signals. In one or more variations, the measured one or more margins are between a first transition of the first signal and one or more second transitions of the second signal. A margin between a timing alignment and misalignment is measurable by any suitable means. In one scenario, the interface circuitry 124 measures a phase difference (e.g., in degrees or picoseconds) between the signals.

In at least one implementation, the interface circuitry 124 is configured to measure one or more alignment margins by a count of delays in a signal path. In some scenarios, the interface circuitry 124 adjusts the timing alignment between the signals (e.g., by iteratively adding delays into at least one signal path) while monitoring whether data is successfully transferred between the devices 126, 202 (e.g., stopping when data is no longer successfully transferred). In one such scenario, an aligned configuration is set based on a maximum data transfer rate between two misaligned configurations. In another such scenario, an aligned configuration is set at a midpoint between two misaligned configurations, e.g., where the data transfer rate is below a minimum threshold. The aligned configuration is (or corresponds to) the desired delay setting (e.g., at the midpoint), and the margins are the number of delays between the aligned configuration (e.g., the iteratively determined midpoint) and the misaligned configurations (e.g., where the data transfer rate is deemed unsatisfactory). Example alignment margins are illustrated and further described at least at FIG. 3.

In at least one implementation, the interface circuitry 124 is configured to store the measured margins (e.g., the magnitude(s) of the margin(s)) between the timing alignments and misalignments of signals by any suitable means, e.g., in any suitable memory. In one or more implementations, the one or more margins are stored in one or more registers. The stored margins can represent any appropriate settings, such as voltage settings, inserted delay or phase settings, etc. In at least one implementation, the one or more margins are simply counts of inserted delays and are stored in a few bits of a single register.

In one or more implementations, the computing device 202 includes other interface circuitries 124 for interfacing with other devices 204. In at least one variation, the interfacing of circuitry 124 with the device 126 and/or other devices 204 includes controlling the device 126 and/or other devices 204. For example, in implementations having a memory device 126 (e.g., as the memory 106 or a portion of the memory 106), the interface circuitry 124 is a memory controller circuitry 124 (e.g., as, including, included in, and/or implemented by the memory controller 132 or a portion of the memory controller 132).

In the example of FIG. 2A, the processing system 100 includes the computing device 202 (e.g., as a portion of the processing system 100 that includes at least the CPU 102), and the interface circuitry 124 shown couples (and interfaces between) the device 126 and one or more portions of the processing system 100 (e.g., the CPU 102). In some examples in which the processing system 100 includes the computing device 202, the system 100 includes the second device 126, e.g., as (or part of) the memory 106, the I/O device 108, the AU 110, the display 130, etc. In another example, the computing device 202 includes the processing system 100, e.g., with the interface circuitry 124 interfacing with (e.g., controlling) an external device 126. For example, the interface circuitry 124 can control a peripheral device 126 with commands and other signals via electrical connections 210.

The connections 210 illustrated in FIG. 2A represent which of the multiple interconnect interfaces 212 shown on the device 202 are coupled to other interconnect interfaces 212 on the device 126, but these connections 210 do not necessarily show routing paths between the interfaces 212. In at least one implementation, the multiple electrical connections 210(1)-210(N) include electrical connections 210 not shown in FIG. 2A, e.g., for illustrative purposes. In one example, the multiple electrical connections 210(1)-210(N) include connections 210 to a vast majority (e.g., nearly every) of interconnect interfaces 212 on the separate device 126. Though electrical connections 210 do not necessarily illustrate actual routing paths between the interfaces 212 of the devices 126, 202, FIG. 2A shows how the electrical connections 210(1)-210(N) can have different lengths and how the insertion of delays, etc., can align the timings of signals on the different connections 210(1)-210(N).

The PCB 206 is a substrate (such as a motherboard or other board) on which components (such as devices 126, 202) are mounted and electrically coupled, e.g., into one or more electrical circuits. In variations, the PCB 206 includes alternating conductive and insulating layers, e.g., with electrical traces running in the conductive layers and vias extending through the insulating layers and coupling between traces in separate conductive layers. The PCB 206 includes multiple interconnect interfaces 212 configured to couple with interfaces 212 on devices 126, 202, e.g., parallel with and directly under interfaces 212 on devices 126, 202. The computing device 202 (e.g., an IC package of the device 202) is coupled with the PCB 206 by multiple interconnect interfaces 212 (e.g., land pads). The second device 126 is similarly coupled with the PCB 206 by multiple interconnect interfaces 212, and devices 126, 202 are coupled by the PCB 206.

An interconnect interface 212 is a structure on a device (e.g., a semiconductor die, an IC package, a memory device (such as a memory module), a socket or other connector (such as a peripheral connector), etc.) or substrate for coupling (e.g., interfacing) electrical interconnects. Examples of interconnect interfaces 212 include (e.g., copper) bond pads, solder bumps or microbumps, package pins (e.g., in a pin grid array (PGA)), lands (e.g., in a land grid array (LGA)), solder balls (e.g., in a ball grid array (BGA)), socket pins, and other contacts. In one or more cases, such as direct-bonded pads on hybrid-bonded semiconductor dies, some coupled interconnect interfaces 212 are directly connected. Notably, in at least one implementation, two coupled interconnect interfaces 212 are indirectly coupled, for example, with both interconnect interfaces 212 directly connected to (e.g., in contact with) the same or different intermediate interconnect interface(s) 212. In one such example, two bond or land pads are coupled by solder or a socket between the pads.

The computing device 202 includes multiple interconnect interfaces 212 (e.g., those interfaces 212 that are part of connections 210(1), 210(2), etc.) configured to couple a CPU (e.g., the CPU 102) with the second device 126. At least some of the interfaces 212 of the computing device 202 are configured to carry the first, second, etc., signals between the devices 126, 202. In the example of FIG. 2A, a first interconnect interface 212 (e.g., a conductive pad) on the package of the device 202 and a second interconnect interface 212 (e.g., another conductive pad) on the PCB 206 are coupled by the socket 208. A third interconnect interface 212 (e.g., a third conductive pad) on the PCB 206 and a fourth interconnect interface 212 (e.g., a fourth conductive pad) on an LPCAMM2 device 126 are coupled by an LPCAMM2 connector (not shown, e.g., a compression connector between the PCB 206 and the LPCAMM2 device 126).

The PCB 206 includes multiple electrical traces configured to carry electrical signals, and the described second and third interconnect interfaces 212 on the PCB 206 are coupled by one such electrical trace. In the case of some such electrical traces, the electrical traces similarly couple a pair of interconnect interfaces 212 on the PCB 206, one interconnect interface 212 configured to couple with a corresponding interconnect interface 212 on a first device (such as the computing device 202) and another interconnect interface 212 configured to couple with a corresponding interconnect interface 212 on a second device (such as the second device 126). In this example, the corresponding electrical connection 210 between the devices 126, 202 includes the electrical trace and the first, second, third, and fourth interfaces 212.

The electrical connection 210 (e.g., including the electrical trace and interfaces 212) couples the interface circuitry 124 (and, e.g., the CPU 102) in the computing device 202 with the memory device 126 of this example. In this and other examples with multiple electrical traces in multiple electrical connections 210, the first interconnect interface 212 is configured to carry a first signal (e.g., via the first electrical connection 210(1) and a first electrical trace through the PCB 206), another interconnect interface 212 on the package of the device 202 is configured to carry the second signal (e.g., via a second electrical connection 210(2) and a second electrical trace through the PCB 206), and so on through an electrical connection 210(N) with an N-th electrical trace through the PCB 206 and a corresponding interconnect interface 212 on the package of the device 202.

In one or more variations where the computing device 202 is coupled with the memory device 126, the first signal (e.g., conveyed via the first connection 210(1)) is a strobe signal (such as a read strobe), the second signal (e.g., conveyed via the second connection 210(2)) is a data signal, and the interface circuitry 124 is configured to adjust the timing alignment between the strobe signal and the data signal. In one or more such scenarios, the interface circuitry 124 adjusts the timing alignment by adjusting a signal-path delay. In at least one scenario, the interface circuitry 124 adjusts the timing alignment by adjusting a voltage. The data signal (and other, e.g., parallel data signals) is identified as a DQ signal, and a corresponding strobe signal is identified as a DQS signal. A strobe signal is a timing or synchronizing signal, like a clock signal, that is not always asserted, e.g., is sometimes tri-stated or otherwise buffered in a high-impedance state. In some memory module examples, a DQS strobe is a bidirectional timing signal, e.g., sourced in a first direction during read operations, sourced in a second direction during write operations, and tri-stated between read and write operations.

The socket 208 includes any suitable structure(s) for coupling the interconnect interfaces 212 of the device 202 and PCB 206, such as socket pins or other conductive structures providing spring force to make and maintain contact with interfaces 212 of the device 202 and the PCB 206. In other examples, interconnect interfaces 212 are coupled by other structures, such as solder, etc. Although FIG. 2A depicts devices 126, 202 as having pad interfaces 212, another example of processing system 100 uses other suitable interconnect interfaces 212, such as pin interfaces 212 on a PGA package.

In at least one implementation, one or both of devices 126, 202 include interconnect interfaces 212 not shown in FIG. 2A, e.g., for illustrative purposes. The device 202 (e.g., the package and interconnect interfaces 212 of the device 202) is configured to couple with one or more other devices 204 through the PCB 206, e.g., by suitable interconnect interfaces 212. In the example of FIG. 2A, the computing device 202 is coupled with multiple devices 204 on the PCB 206 by electrical connections 210 (not shown) through the PCB 206, e.g., by interfaces 212 both shown and not shown in FIG. 2A.

FIG. 2B depicts examples 214, 216, 218 of the processing system 100, including the first device 202 and a second device 126, on a PCB 206.

In the example 214, the processing system 100 includes the computing device 202 coupled with the PCB 206 by a substrate 220, which is coupled by solder 222 to the device 202 above and to the PCB 206 below. The one or more separate devices 126 are coupled with the PCB 206 by solder 222, and devices 126, 202 are coupled by the PCB 206. In one example, a single separate device 126 includes multiple IC dies in separate IC packages coupled to the PCB 206 by solder 222 and interconnect interfaces 212. Groups of first interconnect interfaces 212 on the device 202 and groups of second interfaces 212 on the PCB 206 are coupled by the substrate 220 and by solder 222, and groups of third interfaces 212 on the PCB 206 and groups of fourth interfaces 212 on the separate device 126 are coupled by solder 222. The PCB 206 includes multiple electrical traces 224, and the groups of second and third interfaces 212 on the PCB 206 are coupled by the multiple traces 224. In this example 214, the electrical connections 210 corresponding to and between pairs of coupled first and second interconnect interfaces 212 on devices 126, 202 include the corresponding electrical traces 224 and corresponding first, second, third, and fourth interfaces 212 (as well as solder 222 and substrate 220 of the device 202).

The package of the computing device 202 is also coupled to one or more other devices 204 through substrate 220 (e.g., and traces included in substrate 220) and solder 222. Substrate 220 is a PCB (e.g., similar to the PCB 206) with one or more conductive layers between insulating layers, with electrical traces running in the conductive layer(s), and with interconnect interfaces 212 configured to couple with other interfaces 212 (e.g., on devices 202, 204, and the PCB 206). In one or more variations, the computing device 202 (e.g., an interface circuitry 124) is configured to adjust a timing alignment of signals between a CPU of the computing device 202 and one or more devices 204 coupled with the device 202 and a CPU of the device 202.

In the example 216, a package of the computing device 202 is coupled with the PCB 206 by a socket 208. The separate device 126 is coupled with the PCB 206 by a socket or connector 226, and the devices 126, 202 are coupled by the PCB 206. The electrical connections 210 of the example 216 are similar to those of the example 214, but the groups of first interconnect interfaces 212 on the device 202 and the groups of fourth interfaces 212 on the separate device 126 are coupled with the groups of second and third interfaces 212 on the PCB 206, respectively, by the socket 208 and the connector 226.

The separate device 126 includes multiple chips or packages 228 on a substrate 230 (e.g., a PCB). The substrate 230 of the separate device 126 is coupled with the PCB 206 by a slot connector 226. In one variation, the separate device 126 is a memory device 126, such as a double data rate (DDR) or other DRAM module. In another variation, the separate device 126 is a CAMM device 126 (e.g., with a substrate 230 parallel with the PCB 206) coupled with the PCB 206 by a compression connector 226.

In the example 218, the computing device 202 and the separate device 126 are separate dies (or groups of dies) in a same package, and devices 126, 202 are coupled by multiple electrical connections internal to the shared package. In one implementation, the separate device 126 is an HBM device 126, e.g., a stack of memory dies over or alongside the computing device 202 in the package.

The package containing both of the devices 126, 202 is coupled to one or more other devices 204 through multiple electrical connections 210, e.g., electrical traces 224 in the PCB 206. In one or more variations, the computing device 202 (e.g., an interface circuitry 124) is configured to adjust a timing alignment of signals between a CPU of the computing device 202 and other devices 204.

FIG. 3 includes a block diagram and a timing diagram illustrating a group of electrical connections configured to carry a group of signals between the computing device and the separate device, as well as example timing alignments of signals between the devices.

A block diagram 300 of FIG. 3 shows a group of electrical connections 210 configured to carry a group of signals between the computing device 202 and the separate device 126. Electrical connections 210 (e.g., electrical connections 210(1)-210(N)) include at least interconnect interfaces 212 on both the computing device 202 and the separate device 126, as well as any structures (such as PCB traces) coupling the pairs of interfaces 212 on the devices 126, 202. An interface circuitry 124 in the computing device 202 couples portions of the computing device 202 (such as a CPU 102) with the second device 126.

An example 304 of signals shows a possible allocation or assignment of signals to the electrical connections 210(1)-210(N) between the devices 126, 202. In the example 304, connection 210(1) carries or conveys a strobe signal DQS to and/or from the devices 126, 202, e.g., from the computing device 202 and to the other device 126 during a first operation (such as a write operation) and from the other device 126 and to the computing device 202 during a second operation (such as a read operation). Electrical connections 210(2) through 210(N) carry data signals DQ(0) through DQ(7), etc., between the devices 126, 202. In the example 304, the connections 210(2)-210(9) are part of a data bus carrying a byte of data, e.g., data signals DQ(0)-DQ(7). In one or more variations of example 304, the connections 210(2)-210(N) are part of a data bus carrying more than a byte of data, e.g., data signals DQ(0)-DQ(7), etc.

FIG. 3 includes a timing diagram 302 of example signals DQS, DQ(0), DQ(1) between the devices 126, 202, as well as corresponding example timing alignments of the signals. Dashed lines are used to indicate reference times 306, 308, and a time t on the x-axis increases from the time 306 to the time 308, e.g., with more than four periods or cycles of the signals DQS, DQ(0), DQ(1) elapsing during the time between times 306, 308. Section 310A of the timing diagram 302 is magnified as section 310B to better illustrate the alignment of signals DQS, DQ(0), DQ(1) (e.g., of signals DQ(0), DQ(1) with the DQS signal) and the margins 312 between the alignment and misalignments of signals DQS, DQ(0), DQ(1). Arrows on the DQS signal indicate transitions or edges, e.g., that trigger a transfer of the data in signals DQ(0), DQ(1), etc. Notably, in the example of timing diagram 302, data transfers occur (e.g., are triggered) at both rising and falling edges or transitions of the DQS signal, e.g., as in a DDR system.

Note also that, although single (e.g., single-ended) signals DQS, DQ(0), DQ(1) are shown, differential signals can be used, e.g., with each illustrated signal DQS, DQ(0), DQ(1) representing a pair of complementary signals. High and low states are shown between transitions for data signals DQ(0), DQ(1) to indicate that either state is possible at sample points between the transitions, not to indicate that complementary signals are employed or that undetermined states are present.

As illustrated in section 310B, signals DQS, DQ(0), DQ(1) are well aligned, e.g., following an adjusting of timing alignments between a first (e.g., DQS strobe) signal and second (e.g., DQ(0), DQ(1) data) signals, The pulses of data signals DQ(0), DQ(1) are aligned with (e.g., approximately centered on) the edges or transitions of the strobe signal DQS, e.g., following an approximate aligning of data signals DQ(0), DQ(1). Note that although the signals DQS, DQ(0), DQ(1) are shown with a phase offset (e.g., of 90°) between the strobe signal DQS and either of the data signals DQ(0), DQ(1), the strobe and data signals are in-phase in other examples. In one or more examples, the signals DQS, DQ(0), DQ(1) are all approximately in-phase, e.g., edge-aligned with transitions (whether rising or falling) of the data signals DQ(0), DQ(1) approximately simultaneous with transitions of the strobe signal DQS.

Horizontal arrows (e.g., in the time dimension, parallel with the x-axis) indicate the margins 312_{0A}, 312_{0B} between timing alignment and misalignments of the strobe signal DQS and the data signal DQ(0) (e.g., as measured by the interface circuitry 124) and the margins 312_{1A}, 312_{1B} between timing alignment and misalignments of the strobe signal DQS and the data signal DQ(1) (e.g., as measured by the interface circuitry 124). The margins 312 as shown in FIG. 3 are not necessarily defined as between transitions of aligned signals (such as DQS and DQ(0) or DQS and DQ(1)), but as between points of timing alignment and of timing misalignment. In one example, data from signals DQ(0), DQ(1) are transferred when properly aligned with strobe signal DQS, but not when misaligned.

As described at least at FIG. 2A, the interface circuitry 124 is configured to adjust a timing alignment (e.g., adjust a phase relationship) of signals between the coupled device 126 and (a CPU of) the computing device 202 and to measure and store margins between the aligned timing and a misalignment of the signals. In the example of diagrams 300 and 302, the data signals DQ(0), DQ(1), etc., are first aligned (e.g., achieving an approximate in-phase alignment by iteratively and incrementally delaying any leading DQ signals), and then the data signals DQ(0), DQ(1), etc., and the strobe signal DQS are aligned (e.g., to a target phase relationship of 0°, 90°, etc., that ensures satisfactory data transfer between the devices 126, 202).

In one or more implementations, the interface circuitry 124 is capable of adjusting the timing alignment of the strobe and data signals by any suitable means, e.g., by inserting one or multiple delays (e.g., of delay circuits of 20 ps), one or more phase-shift circuits, etc., into one or more signal paths. In one implementation, a voltage (e.g., to the second device 126 or to the one or multiple delay circuits) is adjusted (e.g., increased or decreased, by the interface circuitry 124 or another portion of the computing device 202) to adjust a relative delay (e.g., phase relationship or timing alignment) between the first and second signals.

In at least one example, the interface circuitry 124 adjusts the timing alignment of the strobe and data signals by shifting, e.g., the strobe signal to the right or left, by adding or removing path delay, to achieve an alignment that ensures satisfactory data transfer between the devices 126, 202. In one or more variations, the interface circuitry 124 first finds (e.g., by adjusting) a timing alignment that enables data transfer between the devices 126, 202 (e.g., in an alignment window or range of satisfactory timing alignments). The interface circuitry 124 then adjusts the timing alignment in a first direction (e.g., by adding path delay) until data is no longer transferred between the devices 126, 202 (e.g., at a first threshold, at a first edge of the alignment window). The interface circuitry 124 finally adjusts the timing alignment in a second direction (e.g., by removing path delay) until data is again transferred and then again no longer transferred between the devices 126, 202 (e.g., at a second threshold, at a second, opposite edge of the alignment window).

In at least one variation, the interface circuitry 124 sets (e.g., adjusts) the timing alignment to a delay setting at a midpoint of the alignment window, between the first and second thresholds (to the first and second directions, respectively) where the data transfer was interrupted. The timing alignment between any two signals is said to be misaligned at (and beyond) these thresholds where the data transfer is interrupted. The times or phase differences (e.g., in both directions) between the timing alignment and the misalignment thresholds define the margins 312. In some variations, the margins 312 are measured by time (e.g., picoseconds), by phase difference (e.g., in degrees, etc.), or by a number of delay units (e.g., a count of delay circuits) inserted into a signal path. In one or more implementations, the computing device 202 (e.g., the interface circuitry 124) stores the margin(s) 312 (e.g., in a register, for comparison to one or more subsequently measured margins 312).

A drift of conditions away from nominal conditions (such as room temperature and a standard supply voltage) can affect operation of the processing system 100, causing a consequent drift of signal timings, even to the point of interrupting functionality of the system 100. The preemptive aligning (or training) of the signal timings at nominal conditions (e.g., at bootup or some other initialization) is repeatable at other, forced conditions to prevent a forced retraining of the timing alignment at an inopportune moment (e.g., during operation). For example, the signal training (including the signal aligning and the margin measuring and storing) can be done at a first condition (or set of conditions), and a second condition can be forced or set on the system before again performing the signal training. The stored margins from the first condition of the system are compared with margins measured and stored at the second condition to model or predict performance at other conditions, whether between or beyond the first and second conditions. In an example, the first and second conditions (e.g., voltages or temperatures) and the first and second alignments and margins are used to calculate a coefficient (e.g., a “drift coefficient”) that accounts for future effects of conditions drifting on the relative timing alignments of the system signals. In one or more variations, the margin comparison is performed by logic (e.g., a comparator) of the computing device 202 (e.g., the interface circuitry 124).

In one or more implementations, the interface circuitry 124 trains the signals (e.g., aligns the signal timings and measures and stores the timing margins) at a nominal first condition (e.g., room temperature and a standard voltage), the processing system 100 (e.g., the interface circuitry 124) forces, establishes, or sets a second condition (such as an elevated temperature or voltage), and the interface circuitry 124 trains the signals again (e.g., aligning the signal timings and measuring and storing the margins) at the second condition. In at least one implementation, the computing device 202 (e.g., the interface circuitry 124) is configured to force at least the second condition, e.g., by raising the temperature of a portion of the processing system 100 and/or by asserting an increased and/or decreased voltage of the processing system 100.

The computing device 202 (e.g., the interface circuitry 124) is configured, in one or more variations, to calculate a drift coefficient, e.g., for modeling or predicting timing drift at a third condition. In one variation, the drift coefficient is calculated from a first difference between the timing alignment at the first condition and the timing alignment at the second condition and from a second difference between the first condition and the second condition. In an example, the drift coefficient is calculated by dividing a first change in the timing alignments (e.g., a reduction in a timing margin) between first and second conditions by a second change between the first and second conditions (e.g., a forced increase or decrease of a system voltage). In another example, the drift coefficient is calculated by dividing a first change in the timing alignments by a second change between the first and second temperatures.

The calculation of the drift coefficient enables the predicting or modeling of system performance at other (e.g., not yet experienced third) conditions, such as temperatures or voltages beyond the forced second condition(s). The predicting or modeling provided by the drift coefficient gives the system a warning before the drifting of the conditions compels a retraining of the system or, even better, enables the system to adjust the signal timings and margins (e.g., on the fly, without a full retraining). In one or more variations, the computing device 202 (e.g., the interface circuitry 124) is configured to calculate one or more third margins at a third condition based on the drift coefficient and to determine whether to adjust the timing alignment (e.g., the phase relationship) at the third condition based on a magnitude of the one or more third margins at the third condition. In at least one variation, the computing device 202 (e.g., the interface circuitry 124) is configured to adjust the timing alignment at the third condition based on the drift coefficient and the one or more third margins.

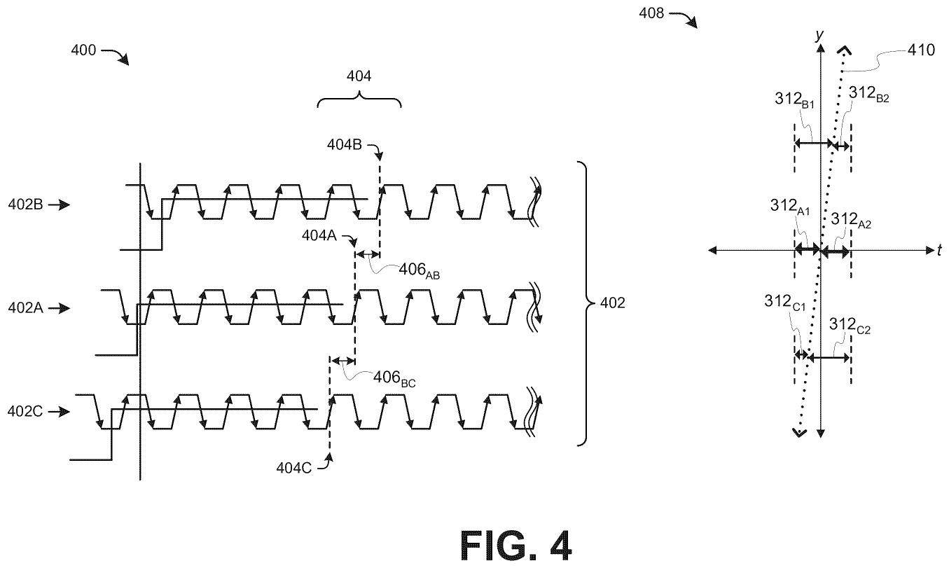

The training (e.g., aligning) of the signals at one or more second conditions and the calculation and implementation of the drift coefficient is described further at FIG. 4.

FIG. 4 includes a timing diagram and a plot illustrating potential effects of drifting conditions on the timing alignments and margins of signals between the computing device and the separate device.

A timing diagram 400 of FIG. 4 shows signal(s) 402, e.g., phase shifted by a forced or drifted condition, such as a voltage or temperature. In one scenario, signals 402A, 402B, 402C are a same signal 402 at different times, e.g., experiencing different stimuli or conditions (e.g., conditions A, B, or C), such as different supply voltage levels or different ambient or operating temperatures. Reference lines 404 (e.g., lines 404A, 404B, 404C) help illustrate phase differences 406 between the signals 402A, 402B, 402C, e.g., with a phase difference 406_{AB} between signals 402A, 402B and a phase difference 406_{BC} between signals 402B, 402C.

In one or more implementations, the interface circuitry 124 is configured to adjust the timing alignment by adjusting a voltage (e.g., of the computing device 202 or other portion of the processing system 100). In some scenarios, signal 402A is a strobe signal generated at a nominal voltage level, signal 402B is a strobe signal generated at a reduced voltage level, and signal 402C is a strobe signal generated at an elevated voltage level, where the processing system 100 (e.g., the computing device 202, etc.) has adjusted a supply or control voltage level influencing or regulating the strobe signal (e.g., to adjust the timing alignment between the strobe signal shown and an associated data signal, not shown). In other scenarios, signals 402A, 402B, 402C (and corresponding phase differences 406_{AB}, 406_{BC}) are caused by drifts in a supply or control voltage level experienced by the computing device 202, e.g., the interface circuitry 124. In yet other scenarios, signals 402A, 402B, 402C (and corresponding phase differences 406_{AB}, 406_{BC}) are caused by drifts in a temperature experienced by the computing device 202 (e.g., the interface circuitry 124) or the other device 126.

A plot 408 of FIG. 4 shows a predicted or modeled behavior of a timing alignment 410 at and between one or more system conditions, such as conditions A, B, and C. The slope of the predicted behavior of the timing alignment 410 is related to a calculated drift coefficient. The slope is interpolated (and the drift coefficient calculated) from the measurements of the margins at different conditions and from the measured (or asserted) values of the conditions. In an example, timing margins 312_{A1}, 312_{A2} represent the measurements at a first condition (e.g., condition A), and timing margins 312_{B1}, 312_{B2} represent the measurements at a second condition (e.g., condition B). In one case, values for the conditions (e.g., temperatures or voltages A and B) are measured (e.g., by a temperature monitor or detector in a memory module or by a voltage detector in a memory module or the interface circuitry 124). In another case, programmed values for the conditions (e.g., voltages A and B) are used in a calculation of the drift coefficient. In another example, a different pair of timing margins (e.g., margins 312_{A1}, 312_{A2} and 312_{C1}, 312_{C2} or margins 312_{B1}, 312_{B2} and 312_{C1}, 312_{C2}) and a different pair of conditions (e.g., conditions A and B or conditions B and C) are utilized.

Although a time t is preserved as the x-axis variable (e.g., to maintain a consistent visualization of the horizontal margins 312 from FIG. 3), the plot 408 shows the effect of changing an independent variable y on the timing alignment 410 and margins 312. The independent variable y represents temperature, voltage, or other varying stimuli. For example, as the variable y increases from a first condition (e.g., condition A) to a second condition (e.g., condition B), the right-side timing margin 312 decreases (e.g., from a larger margin 312_{A2} to a smaller margin 312_{B2}), and the left-side timing margin 312 increases (e.g., from a smaller margin 312_{A1} to a larger margin 312_{B1}). The slope of the timing alignment 410 as illustrated in the plot 408 is inversely related to a drift coefficient having a timing or phase misalignment or margin in the numerator, e.g., dependent on a voltage, temperature, etc., in the denominator,

The drift coefficient (e.g., calculated from the first and second margins 312 at the first and second conditions) enables the modeling of system performance at not yet experienced conditions, e.g., providing knowledge (or at least a prediction) of the signal timings and margins at a higher or lower voltage. In one or more variations, the computing device 202 (e.g., the interface circuitry 124) is configured to calculate one or more third margins at a third condition based on the drift coefficient (e.g., based on the first and second margins 312) and to determine whether to adjust the timing alignment (e.g., the phase relationship) at the third condition based on a magnitude of the one or more third margins at the third condition. For example, a drift coefficient calculated from the timing margins 312_{A1}, 312_{A2}, 312_{B1}, 312_{B2} (e.g., at conditions A and B) predicts the timing margins 312_{C1}, 312_{C2} at condition C, which are not as balanced and comfortable as the margins 312_{A1}, 312_{A2}, but are no more lopsided or marginal than margins 312_{B1}, 312_{B2}.

In at least one implementation, one or more portions of the computing device 202 (e.g., the interface circuitry 124 and/or the CPU 102) is configured to output an indication of whether to readjust the timing or phase alignment between the first signal and the second signal at the third condition based on the one or more first margins and the one or more second margins. In one variation, the timing margins 312_{C1}, 312_{C2} (e.g., based on the first and second margins 312_{A1}, 312_{A2}, 312_{B1}, 312_{B2} used to calculate the drift coefficient) are compared to thresholds to decide or determine an indication (e.g., a pass/fail indication) whether or not the timing or phase alignment should be readjusted. In an example, an indication that the timing or phase alignment should be readjusted is output (e.g., by the interface circuitry 124 to the CPU 102) based on a sign and/or magnitude of one or more of the timing margins 312_{C1}, 312_{C2} (e.g., if margins 312_{C1}, 312_{C2} are negative values or only small positive values). In one example, the interface circuitry 124 is configured to output the indication to the CPU 102. In another example, the CPU 102 is configured to output the indication to the interface circuitry 124.

If the predicted timing margins 312_{C1}, 312_{C2} for condition C are deemed insufficient (e.g., by the interface circuitry 124 or by the CPU 102), the drift coefficient enables the readjusting or reprogramming of the alignment and margins without having to execute an iterative retraining of the timing alignment. In at least one variation, the computing device 202 (e.g., the interface circuitry 124) is configured to adjust the timing alignment at the third condition based on the drift coefficient and/or the one or more third margins. The drift coefficient provides the system 100 (e.g., the interface circuitry 124) with the knowledge (or at least a prediction) of how much delay the interface circuitry 124 should add or remove to maximize the timing margins 312_{C1}, 312_{C2}.

In one or more variations, the computing device 202 (e.g., the interface circuitry 124) is configured to calculate a drift coefficient from a first difference between the timing alignment at the first condition and the timing alignment at the second (and/or third) condition and from a second difference between the first condition and the second (and/or third) condition (e.g., a voltage or temperature difference). In at least one example, the (first) difference between the timing alignments at the first and second conditions is equivalent to a same difference between the first and second margins at the first and second conditions. In one or more variations, the computing device 202 (e.g., the interface circuitry 124) is configured to calculate a drift coefficient from a first difference between the first margins (e.g., margins 312_{A1}, 312_{A2}) at the first condition and the second margins (e.g., margins 312_{B1}, 312_{B2}) at the second condition and from a second difference between the first condition and the second condition.

Again, in this example, the timing alignment is between a shown strobe signal 402 (e.g., signal 402A, 402B, or 402C) and an associated data signal (not shown) at a given condition (e.g., a condition A, B, or C), such as a voltage or temperature. In at least one variation, the computing device 202 (e.g., the interface circuitry 124) is configured to force, establish, etc., the second (and/or third) condition.

In one variation, the computing device 202 (e.g., the interface circuitry 124) is configured to raise the temperature of a portion of the processing system 100 (e.g., the interface circuitry 124 or the other device 126). In an example, the computing device 202 (e.g., the interface circuitry 124) is configured to raise the temperature by increasing a voltage, frequency, and/or duty cycle of one or more supplies and/or signals (e.g., to the other device 126). In another example, the computing device 202 (e.g., the interface circuitry 124) is configured to raise the temperature by energizing a heating element. In one variation, the computing device 202 (e.g., the interface circuitry 124) is configured to assert and increased and/or decreased voltage of the processing system 100 (e.g., to the second device 126 or to one or more delay circuits in the interface circuitry 124).

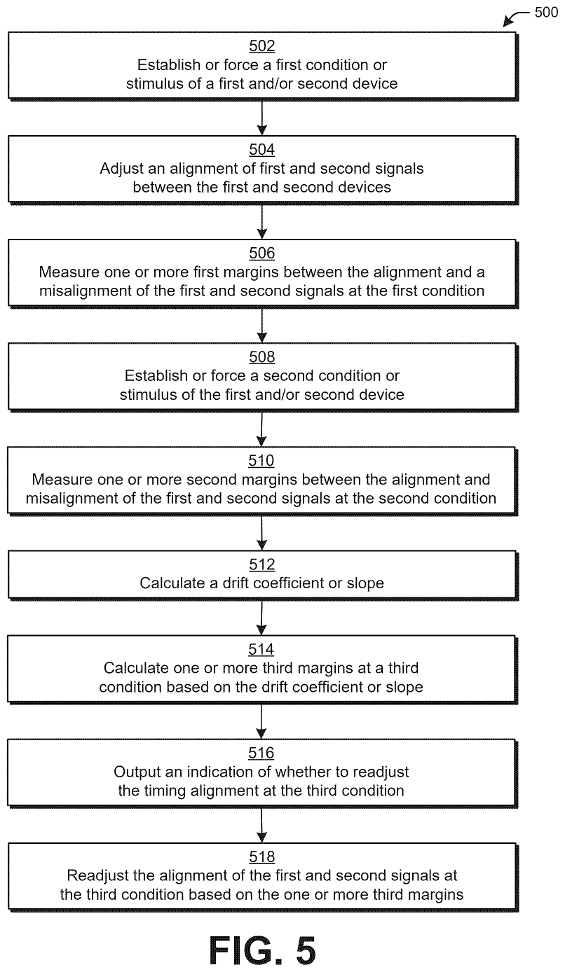

FIG. 5 depicts a procedure 500 in an example implementation of adjusting an alignment of first and second signals between first and second devices and of measuring margins between alignment and misalignments of the signals at first and second conditions.

A first condition of (or stimulus to) one or both of first and second devices is forced (or established, asserted, etc.) at block 502. As described at least at FIGS. 3 and 4, a computing device 202 is configured to set or force one or more conditions (such as a voltage, temperature, etc.) of the system 100. In some scenarios, nominal conditions (e.g., an ambient or equilibrium temperature) provide the first condition(s).

An alignment of first and second signals between the first and second devices is adjusted at block 504. The computing device 202 is configured to adjust the alignment between the signals, as described at least at FIGS. 2A, 3, and 4. In at least one implementation, the alignment of the first signal and the second signal is adjusted by adjusting a voltage of the first device or the second device, e.g., to increase or decrease a delay of one of the first and second signals.

One or more first margins between the alignment and a misalignment of the first signal and the second signal at the first condition are measured at block 506. The computing device 202 is configured to measure and store the margins, as described at least at FIGS. 2A, 3, and 4.

A second condition of (or stimulus to) one or both of the first and second devices is forced (or established, asserted, etc.) at block 508. The computing device 202 is configured to set or force one or more conditions (such as a voltage, temperature, etc.) of the system 100, as described at least at FIGS. 3 and 4.

One or more second margins between the alignment and misalignment of the first signal and the second signal at the second condition are measured at block 510. The computing device 202 is configured to measure and store the margins, as described at least at FIGS. 2A, 3, and 4.

A drift coefficient is calculated at block 512. The computing device 202 is configured to calculate the drift coefficient, as described at least at FIGS. 3 and 4. In some scenarios, the drift coefficient is calculated from a first difference between the one or more first margins at the first condition and the one or more second margins at the second condition and from a second difference between the first condition and the second condition, such as a voltage or temperature difference.

One or more third margins at a third condition are calculated based on the drift coefficient or slope at block 514. The computing device 202 is configured to calculate the third margins based on the drift coefficient, as described at least at FIGS. 3 and 4.

An indication of whether to readjust the timing alignment at the third condition is output at block 516. One or more portions of the computing device 202 (e.g., the interface circuitry 124 and/or the CPU 102) are configured to output the indication based on the third margins (e.g., based on and calculated from the first and second margins), as described at least at FIG. 4. In one example, the interface circuitry 124 is configured to output the indication to the CPU 102. In another example, the CPU 102 is configured to output the indication to the interface circuitry 124.

The alignment of the first and second signals at the third condition is readjusted based on the one or more third margins at block 518. In one example, the readjusting is performed (or not) based on the indication outputted at block 516. The computing device 202 is configured to readjust the alignment based on the third margins, as described at least at FIGS. 3 and 4.

A number of implementations have been described. Nevertheless, it will be understood that various modifications may be made without departing from the spirit and scope of the disclosure. Accordingly, other implementations are within the scope of the following claims.

What is claimed is:

1. A computing system, comprising:
an interface circuitry configured to:
adjust a timing alignment between a first signal and a second signal transmitted between a central processing unit (CPU) of the computing system and a device coupled with the CPU;
measure and store one or more first margins between the timing alignment and a misalignment of the first signal and the second signal at a first condition and one or more second margins between the timing alignment and the misalignment of the first signal and the second signal at a second condition; and
output an indication of whether to readjust the timing alignment between the first signal and the second signal at a third condition based on the one or more first margins and the one or more second margins.

2. The computing system of claim 1, wherein the computing system is configured to calculate a coefficient from:
a first difference between the one or more first margins at the first condition and the one or more second margins at the second condition; and
a second difference between the first condition and the second condition.

3. The computing system of claim 2, wherein the computing system is configured to:
calculate one or more third margins at the third condition based on the coefficient; and
output the indication of whether to readjust the timing alignment at the third condition based on a magnitude of the one or more third margins at the third condition.

4. The computing system of claim 3, wherein the interface circuitry is configured to readjust the timing alignment at the third condition based on the coefficient and the one or more third margins.

5. The computing system of claim 4, wherein the interface circuitry is configured to adjust the timing alignment by adjusting a voltage of the computing system.

6. The computing system of claim 1, wherein the interface circuitry is configured to force at least the second condition.

7. The computing system of claim 1, wherein:
the first condition comprises a first voltage; and
the second condition comprises a second voltage.

8. The computing system of claim 1, wherein:
the first condition comprises a first temperature; and
the second condition comprises a second temperature.

9. The computing system of claim 1, further comprising the device, wherein:
the device comprises a memory module; and
the CPU is coupled to the memory module via a first trace and a second trace, the first trace configured to carry the first signal, the second trace configured to carry the second signal.

10. The computing system of claim 9, wherein:
the first signal is a read strobe;
the second signal is a data signal;
the device is coupled with the CPU by a printed circuit board, the printed circuit board comprising the first trace and the second trace; and
the interface circuitry is configured to adjust the timing alignment between the read strobe and the data signal by adjusting a voltage.

11. A computer-implemented method, comprising:
adjusting an alignment of a first signal and a second signal between a first device and a second device;
measuring at a first condition one or more first margins between the alignment and a misalignment of the first signal and the second signal;
measuring at a second condition one or more second margins between the alignment and the misalignment of the first signal and the second signal; and
outputting an indication of whether to readjust the alignment of the first signal and the second signal at a third condition based on the one or more first margins and the one or more second margins.

12. The computer-implemented method of claim 11, further comprising:
forcing the first condition; and
forcing the second condition.

13. The computer-implemented method of claim 11, further comprising calculating a drift coefficient from:
a first difference between the one or more first margins at the first condition and the one or more second margins at the second condition; and
a second difference between the first condition and the second condition.

14. The computer-implemented method of claim 13, further comprising:
calculating one or more third margins at the third condition based on the drift coefficient; and
adjusting the alignment of the first signal and the second signal at the third condition based on the one or more third margins.

15. The computer-implemented method of claim 11, further comprising adjusting the alignment of the first signal and the second signal by adjusting a voltage of the first device or the second device.

16. A computing system, comprising:
a printed circuit board comprising at least a first trace and a second trace, the first trace configured to carry a first signal, the second trace configured to carry a second signal;
a first device on the printed circuit board, the first device configured to communicate with a second device by the first trace and the second trace; and
the second device on the printed circuit board, configured to:
adjust a phase relationship between the first signal and the second signal;
measure and store one or more first margins between a first transition of the first signal and one or more second transitions of the second signal at a first condition and one or more second margins between the first transition of the first signal and the one or more second transitions of the second signal at a second condition; and
output an indication of whether to readjust the phase relationship between the first signal and the second signal at a third condition based on the one or more first margins and the one or more second margins.

17. The computing system of claim 16, wherein the computing system is configured to calculate a coefficient from:
a first difference between the one or more first margins at the first condition and the one or more second margins at the second condition; and
a second difference between the first condition and the second condition.

18. The computing system of claim 17, wherein the computing system is configured to:
calculate one or more third margins at the third condition based on the coefficient; and
output the indication of whether to readjust the phase relationship at the third condition based on a magnitude of the one or more third margins at the third condition.

19. The computing system of claim 18, wherein the computing system is configured to readjust the phase relationship at the third condition based on the coefficient and the one or more third margins.

20. The computing system of claim 16, wherein:
the first condition comprises a first voltage; and
the second condition comprises a second voltage.
